(19) United States
(12) Patent Application Publication
(10) Pub. No.: US 2004/0024646 A1
(43) Pub. Date: Feb. 5, 2004

(54) System and method for automated authorization for service provider switching

(76) Inventors: James Iry, Austin, TX (US); Caden Schaefer, Cedar Park, TX (US); David L. Hughart, Austin, TX (US)

Correspondence Address: HULSEY & CALKINS, LLP, 8911 N. Capital of Texas Highway, Suite 3200, Austin, TX, 78759, US

(21) Appl. No.: 10/209,074

(22) Filed: Jul. 31, 2002

(51) Int. Cl. G06F 17/60

(52) U.S. Cl. 705/26; 709/226

(57) ABSTRACT

The invention is directed to a system and method for automating authorization processes. The system may include a computer implement system for generating and processing electronic letters of agency and third-party verifications. Further, the system may provide a web-based access to service providers for verifying customer orders. In addition, the system may implement a queue process in which various orders may be associated with various queues for processing and exception handling. The orders may be associated with the various queues in accordance with order status data provided by the service provider, data provided through the order process, and information from the electronic letter of agency or third party verification process, among others. In this manner, much of the order processing and agency authorization and verification may be automated decreasing agency and service provider costs and order time.

### TECHNICAL FIELD OF INVENTION

This invention relates, in general, to a method for automating authorization and letters of agency processing. More specifically, this invention relates to the automated processing of letters of agency and order reports used in a process for initiating a purchase and maintaining order records.

### BACKGROUND OF THE INVENTION

The wide spread use of the Internet facilitated change in various business-to-consumer interactions. For example, various auction and price specification models have been introduced for the purchase of airline tickets and used goods.

In some industries, the Internet has facilitated an increase in information and access to consumers. Consumers are provided with more options and greater selection in choosing service plans and goods between competing providers.

One such industry is the telecom industry. Deregulation through the Telecom Act of 1996 greatly expanded the number of long distance and local carriers. The number of long distance providers increased from a few to as many as 1500. Similarly, the number of competitive local carriers increased to as many as 500. The number of providers of broadband service will likely follow suit.

To differentiate themselves, the service providers create rate plans that focus on narrow segments of the market. As such, consumers must evaluate several plans to determine which one best suits their individual usage habits. Finding the best plan becomes increasingly time consuming.

Many of these providers also rely on extensive marketing campaigns or agency services to acquire customers. Many agency services use telemarketing, sweepstakes, tarot card reading and other gimmicks to acquire customers. In some cases these agencies have acted unscrupulously and switch consumers without permission.

For this reason, States have implement rules and regulations to prevent unauthorized switching of consumers from one service provider to another. These rules typically require third party verification or a letter of agency to permit switching or initiating a service.

As such, many agency services seek to acquire a signed statement or use third-party verification systems to obtain the authorization required. In the case of telemarketing, a potential customer may be transferred to a third party verifier to acquire verbal confirmation of the order. In other cases, the potential customer may be required to sign and return a form or respond to an automated phone call. In the case of a signed letter of authorization, the customer must take time to sign the form, seal an envelope, and mail the letter. In the case of the automated phone call, time and costs may increase with missed phone calls or incorrect responses. Moreover, each of these cases requires costly personnel for processing and confirming the identity and desire of the potential customer. These methods are also prone to human error.

Once the order is submitted, telecom companies may receive complaint by consumers who object to the switching of the service. In these cases, the telecom company must verify the authorization. Typically, this verification requires thumbing through files to find signatures or searching records to find verification information. These processes are costly and prone to error, too.

Similarly, the agency services must confirm and process feedback from the telecom service providers to insure proper order status and payment of commissions. Processing telecom statements and data files may be time consuming and require personnel to verify order status.

As such, many agency services and purchasing systems are costly, error prone, and time consuming. Many other problems and disadvantages of the prior art will become apparent to one skilled in the art after comparing such prior art with the present invention as described herein.

### SUMMARY OF THE INVENTION

Aspects of the invention may be found in a method of providing a selection of a verification method in association with an order. The system may offer the customer the option to select from a third-party verification phone call, an electronic letter of authorization/agency, or a written letter of authorization/agency, among others. In the case of a third-party verification, the consumer may specify a time and/or day for receiving the phone call. In the case of an electronic letter of verification, the customer may be provided with an email or a website with a text letter and a means of confirming identity and interest in switching. In the case of a written letter of authorization, the letter may be automatically processed and prepared for sending to the customer.

Further aspects of the invention may be found in an electronic letter of authorization/agency (ELOA) and method for providing and processing the ELOA. The ELOA may have a text specific to an associated service provider or applicable laws and regulations. The ELOA may also have instructions on completion of an order associated with the ELOA. Further, the ELOA may have a means for confirming an order. This means may be a button on a website or a return email address, among others.

Another aspect of the invention may be found in processing the ELOA. The ELOA may be composed by appending text associated with a specific service provider to the instructions for completing the ELOA/order process. The ELOA may then be provided to the customer as an email or a web page. The customer may respond through email or by pressing a button provided on a web page. The returned ELOA may then be processed through an automated system. The automated system may read the ELOA and determine from the amount of text, keywords, and other factors whether the ELOA is valid. If the ELOA appears invalid, the system may move the ELOA to a folder for further processing. The further processing may include applying various business rules to the ELOA. If the ELOA is valid, the ELOA may be stored in a service provider accessible database and the order completed. If the ELOA is not returned, a subsequent ELOA may be sent with further instructions. Further, if in placing the order with the service provider an exception is discovered, the ELOA process may be repeated and an explanation of the exception may or may not be provided to the customer.

Another aspect of the invention may be found in a method of verifying order status and associating the order status with a customer order. A service provider may provide a listing of customers with status codes. The listing of customers may be compared to a database of customers. The order may then be arranged into queues based on business rules associated with the status codes. In this manner, the system may process various queues of orders and perform functions associated with the queue. For example, one queue may require re-verification through the ELOA system. Alternately, one queue may discard orders. Additionally, queues may require manual processing, verification of commission, and other functions.

Further aspects of the invention may be found in a system for processing orders. This system may, for example, be a set of instructions and computer-implemented programs for processing orders. The system may have an order interface, a verification system, a provider report reconciliation system, a commission verification system, a profile engine, a consumer notification engine, and various databases. These elements may be implemented together, separately, or in various combinations. Further, these elements may interface to provide combined functionality. The verification system may have a purchaser contact engine with TPV interfacing, ELOA systems, and written letters of agency systems. The verification system may also have a order/exception handling interface/engine. The ELOA system may include an ELOA generator, filtering rules, folders, exception handling rules, an email system, text files, provider interfaces, databases and other interfaces.

Another aspect of the invention may be found in a system and method for verifying commissions. The system may include computer interpreted scripts or software instructions for receiving and processing service provider reports. The system may also have instructions for applying commission rules to data from the reports and comparing the result to payments provided. However, the comparison may be performed manually.

Another aspect of the invention may be found in a system for notifying customers. The system may interact with other systems to determine when a change in an order or customer record has occurred. The system may have instructions and interfaces for notifying the customer of the change.

As such, a system for automated processing of letters of agency and service provider orders is described. Other aspects, advantages and novel features of the present invention will become apparent from the detailed description of the invention when considered in conjunction with the accompanying drawings.

### BRIEF DESCRIPTION OF DRAWINGS

For a more complete understanding of the present invention and advantages thereof, reference is now made to the following description taken in conjunction with the accompanying drawings in which like reference numbers indicate like features and wherein:

FIG. 1 is a schematic block diagram depicting a system according to the invention;

FIG. 2 is a block flow diagram depicting a method for use with the system as seen in FIG. 1;

FIG. 3 is a block diagram depicting an exemplary embodiment of an order system as seen in FIG. 1;

FIG. 4 is a block diagram depicting an exemplary embodiment of a verification system as seen in FIG. 3;

FIG. 5 is a block flow diagram depicting an exemplary method for use by the verification system as seen in FIG. 4;

FIG. 6 is a block diagram depicting an exemplary embodiment of a TPV interface as seen in FIG. 4;

FIG. 7 is a block flow diagram depicting an exemplary method of a TPV system as seen in FIG. 4;

FIGS. 8A and 8B are a table depicting an exemplary report resulting from the TPV system specified in FIG. 7;

FIG. 9 is a table depicting an exemplary report resulting from the TPV system specified in FIG. 7;

FIG. 10 is a block diagram depicting a exemplary embodiment of a ELOA system as seen in FIG. 3;

FIG. 11 is a block flow diagram of an exemplary method for use by the ELOA system as seen in FIG. 10;

FIG. 12A is a pictorial representation depicting an exemplary embodiment of an ELOA as seen in FIG. 11;

FIG. 12B is a pictorial representation depicting an exemplary embodiment of an ELOA as seen in FIG. 11;

FIG. 13 is a pictorial representation depicting an exemplary embodiment of a TPV scheduling system as seen in FIG. 11;

FIG. 14 is a block flow diagram of an exemplary method for use by the ELOA system as seen in FIG. 10;

FIGS. 15A and 15B are a pictorial representation depicting an exemplary embodiment of an ELOA as seen in FIG. 14.

FIG. 16 is a block flow diagram depicting an exemplary method for ELOA processing for use by the system as seen in FIG. 10;

FIG. 17 is a block flow diagram depicting another exemplary method for ELOA processing for use by the system as seen in FIG. 10;

FIGS. 18A and 18B are a block flow diagram depicting a further exemplary method for ELOA processing for use by the system as seen in FIG. 10;

FIG. 19 is a block flow diagram depicting another exemplary method for ELOA processing for use by the system as seen in FIG. 10;

FIG. 20 is a pictorial representation depicting a login page for a service provider for use by the system as seen in FIG. 10;

FIG. 21 is a pictorial representation depicting a query page for a service provider for use by the system as seen in FIG. 10;

FIG. 22 is a pictorial representation depicting a query result page for a service provider for use by the system as seen in FIG. 10;

FIG. 23 is a pictorial representation depicting a verified ELOA provided to the service provider for use by the system as seen in FIG. 10;

FIG. 24 is a block diagram depicting an exemplary embodiment of a Provider Report Reconciliation System as seen in FIG. 3;

FIG. 25 is a block flow diagram depicting an exemplary method for use by the system as seen in FIG. 24;

FIG. 26A depicts an exemplary embodiment status report;

FIG. 26B is a table depicting an exemplary embodiment of status codes;

FIG. 26C is a table depicting an exemplary embodiment of rules associated with status codes;

FIG. 27 is a schematic block diagram depicting an exemplary embodiment of a customer notification system;

FIG. 28 is a block diagram depicting an exemplary embodiment of a Commission Verification System as seen in FIG. 3; and

FIG. 29 is a block flow diagram depicting an exemplary method for use by the system as seen in FIG. 28.

Corresponding reference numerals indicate corresponding parts throughout the several views of the drawings.

### DETAILED DESCRIPTION OF THE INVENTION

The invention relates to online ordering of service and goods through agency services or for which third party verification or letters of agency are required. Such services and goods include various telecommunications products such as long distance, local carrier service, wireless service and potentially broadband access. However, the invention may be used in various industries.

For example, in the telecommunications industry, states may require third-party verification, verification of identity, and/or letters of agency/authorization for initiating and/or switching service. As such, orders must be processed through such verification and authorization systems.

In 2000, the Electronic Signatures in Global and National Commerce Act established precedent for using electronic verification means to verify identity and authorizing agency. This invention relates to the application of that precedent to letters of agency for switching or initiating services. Moreover, the invention relates to the automated processing of such orders in association with the ELOAs and/or data provided by service providers. In addition, the invention allows for exception handling and queuing of orders for processing.

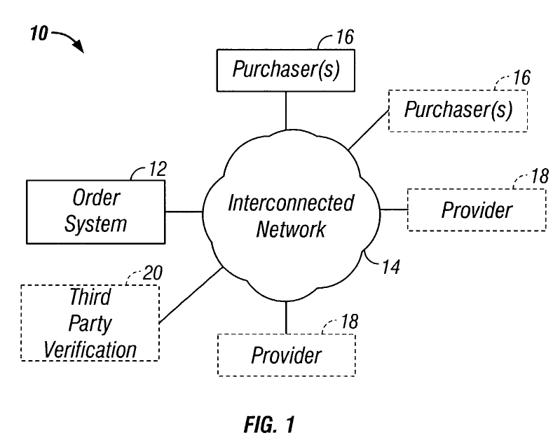

FIG. 1 is a schematic block diagram depicting a system according to the invention. The system 10 may have an order processing system 12 or systems coupled to an interconnected network 14. One or more purchasers may access the order system through the interconnected network 14 and place or research orders through the order system 12. The purchasers 16 may then order products or services from providers 18 through the order system 12. The order system 12 may, as part of the order process, permit selection of a method of verification or authorization. The purchaser may or may not request third-party verification (TPV) or the use of an electronic letter of agency (ELOA) or written letter of agency (WLOA).

In the case of TPV, the order system 12 may automatic contact a TPV system 20 and arrange for TPV. In the case of ELOA, the order system 12 may provide an email or website, among others, to the purchaser 16 through the interconnected network 14. The purchaser may then respond with authorization and/or an electronic signature. The electronic signature may take the form of network data, electronic keys, encryption, and time or date stamp, among others. The order system 12 may then process the returned ELOA.

Once verification or authorization is received, the order system 12 may contact the provider 18. For example, the order system 12 may post data to the providers 18 through the interconnected network 18. Alternately, the order system may prepare a paper order, fax order, data file, or other order form and provide that to the providers 18. However, various means of order processing may be envisaged.

Furthermore, the providers 18 may access data on the order system 12. For example, the providers 18 may access information relating the third party verification system 20 or the ELOA through a web-based system. The provider 18 may then verify that orders are properly placed and verified or authorized.

The order system 12 may take various forms. These forms may include one or more computers or servers and/or various software components and elements. The order system may also include interfaces with various hardware components such as printers, databases, hard drives, user interfaces, and modems, among others. Furthermore, the elements of the order system 12 and various sub-components may be implemented in software as separate programs, various integrated programs, or a large program. In addition, the components may represent functionality created through the combination of sub-parts and functions within various programs.

The interconnected network 14 may take various forms. These forms may include a global network comprising wired and wireless networks using various standards and protocols including, but not limited to, HTTP, FTP, SNMP, DMI, TCP/IP, Ethernet, Wireless Ethernet, and Blue Tooth®, among others.

The purchaser 16 may access the order system 12 and the interconnected network 14 through various methods. These methods may include a browser enabled computer, phone, smart device, handheld circuitry, and kiosk, among others. However, various methods may be envisaged

The provider 18 may also access the order system 12 and the interconnected network 14 through various methods. These methods may include browser enabled computers, servers, phones, smart devices, handheld circuitry, and kiosks, among others. However, various methods may be envisaged.

Further the third-party verification system 20 may take various forms. These forms may include an automated calling system and a call center, among others.

However, various forms of the system 10 may be envisaged. These elements may or may not be included and may or may not be together, separate or in various combinations and configurations.

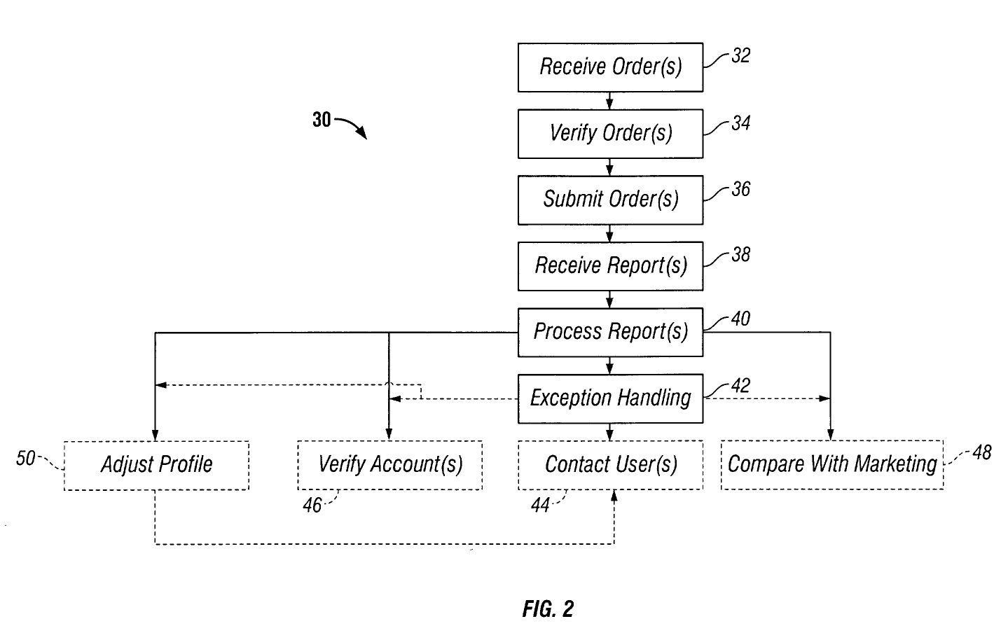

FIG. 2 depicts a method for using the system seen in FIG. 1. In the method 30, the order system may receive an order as seen in a block 32. For example, the order may be received through a website. The ordering process may also include a selection of a verification or authorization process. However, the verification or authorization process may be predetermined in accordance with provider preference, regional laws, and agency service preference, among others.

The order may then be verified, authenticated, or authorized as seen in a block 34. This verification may include third party verification, an ELOA process, or a WLOA. For example, the third-party verification may include an automated call process or a call from a call center. The TPV system may return a report with verification information or status information.

The ELOA may be a web page or email message including letter of agency text and a method of responding with an electronic signature. The ELOA may be further processed to determine status and validity. Alternately a written form of the letter of agency may be sent (WLOA).

Once an order has been verified, authenticated, or authorized, it may be submitted as seen in a block 36. For example, the order may be submitted through an HTTP Post to a server at the service provider. Alternately, submitting the order may include preparing a data file, printing a form, sending a fax, sending data through FTP, sending a letter, and/or calling an representative, among others.

The service provider may then send periodic reports as seen in a block 38. The report may include some, all, or none of the previously submitted orders. The report may be associated with the service provider and may have an order or customer identification number and an associated status code, among others. The report may take various forms including flat files, text files, database files, and XML files, among others. Further, the report format may vary between service providers.

However, the report may be sent periodically whether orders are submitted or not. Further the receiving of the report may occur concurrently with other steps in the method 30.

The report may be processed as seen in a block 40. The processing may include associating the status codes with orders and customer records using the order or customer identification number and/or other data. In one exemplary embodiment, the report may be a listing of customer phone numbers and TCSI codes. In some cases, the report may indicate that a customer is continuing to use the service. In other cases, the report may indicate a status differing from the expected status. Further, one or more customer numbers from the report may not match with orders. In addition, other exceptions and errors may be found.

Moreover, service providers may provide the report in varying forms. The system may be programmed to identify the report format and/or process the report accordingly.

If exceptions exist, the orders may be placed in a queue according to business rules as seen in a block 42. The queue may take various forms including sorted folders, directories, or record tables, among others. The business rules may for example use the status code and other data to determine an appropriate action.

For example, if the status code indicates a recent change, a successful switching, or a problem with the order, the purchaser may be contacted as seen in a block 44 with an appropriate message and/or request for further action. This contact may be an email message, an ELOA, a website, a phone call, another TPV attempt, a WLOA, or a written correspondence, among others. However, various actions may be envisaged.

The report data or data from another provider report may also be used to verify accounting information as seen in a block 46. For example, the service provider may pay commissions to the agency service based on aspects of a contract or usage habits of the purchasers. The data may be used in conjunction with contract data or commission schedules, among others, to determine the expected commission amount. However, various methods for determine and paying an agency service may be envisaged and incorporated in the account verification. The verification may also use exception data.

In another example, the report or other data may be used to determine usage habits of one or more purchasers. This information may be used in reevaluating a purchasers profile and determining a more optimal plan or service provider. The result of the reevaluation may then be communicated to the customer through various means. Alternately, the data may be used to refine parameters associated with the service provider or generic profiles used to categorize consumers and their usage habits. The profile adjustment may also use exception data.

In a further example, the report data may be used to compare commissions, customer retention, customer conversion rates, return on investment and other factors associated with marketing efforts to evaluate associated marketing efforts as seen in a block 48. In this manner, a measure of a marketing program may be developed. As a result, successful marketing campaigns may be promoted and unsuccessful ones abandoned.

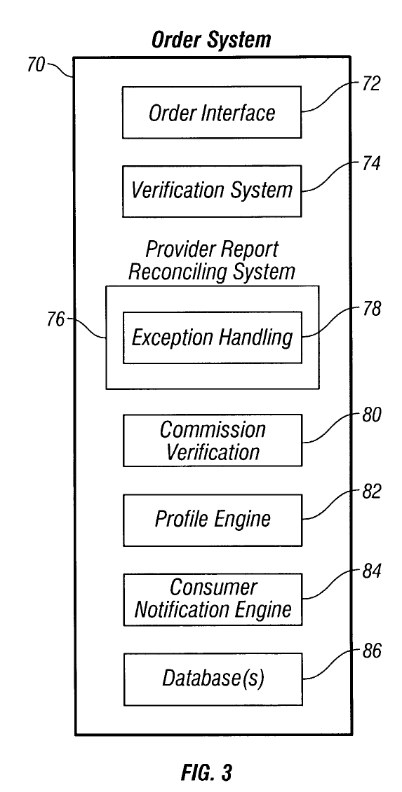

To accomplish this method, the order system may have various elements. FIG. 3 shows a exemplary embodiment of an order system 70. The order system 70 may have an order interface 72, a verification system 74, a provider report reconciliation system 76 with exception handling 78, a commission verification system 80, a profile engine 82, a consumer notification engine 84, and databases 86, among others. However, these elements may or may not be included and may be together, separate, or in various combinations. The order system 70 may for example take the form of one or more servers, computer terminals, and networked devices, among others. Furthermore, the elements of the order system 70 and various sub-components may be implemented in software as separate programs, various integrated programs, or a large program. In addition, the components or elements shown below may represent functionality created through the combination of sub-parts and functions within various programs.

The order interface 72 may take various forms. These forms may include a website, an order form, a kiosk program, an email, and a phone system, among others. For example, the order interface 72 may be a website through which a purchaser enters information. Alternately, the order interface 72 may be an email notifying a customer of a better service plan. However, various interfaces may be envisaged.

The verification system 74 may function to verify the identity of the purchaser through a phone call, ELOA, WLOA, or other methods. For example, the purchaser may schedule a TPV system call or indicate a desire to submit an ELOA with an electronic signature. The verification system 74 may also function to handle exceptions and errors in the verifications. Further, the verification system may permit access by service providers.

The provider report reconciliation system 76 may receive and process service provider reports. This system 76 may allocate and/or switch orders among various queues in response to data in the report. Further the system 76 may process reports with varying formats and permit exception handling. This exception handling may include interfacing with the verification system 74 or notifying an attendant of a problem with an order, among others.

Further, the provider report reconciliation system 76 may interface with a commission verification system 80 to verify proper payment of commissions. The provider report reconciliation system 76 may also interface with a profile engine 82 to adjust profile parameters or determine more optimal service plans for customers.

The commission verification system 80 may use data from various provider reports including order status or usage reports. For example, the commissioner 80 may use data from a usage report to determine or verify proper payment of commissions.

Further, these systems 74, 76, and 82 may interface with a consumer notification engine 84 to interact with the consumer. The consumer notification engine 84 may be used to notify consumers of better plans, ELOAs, and/or order status, among others. The consumer notification engine 84 may, for example, take the form of an email engine, website, or combination, among others.

Further, the order system 70 may have one or more databases 86. The database may contain data associated with orders, consumers, purchasers, service providers, profiles, commissions and schedules, business logic rules, status codes, and customer or order identification numbers, among others.

The order system 70 may take various forms. These forms may or may not include each of these elements together, separately, or in various combinations. As such, various embodiments may be envisaged.

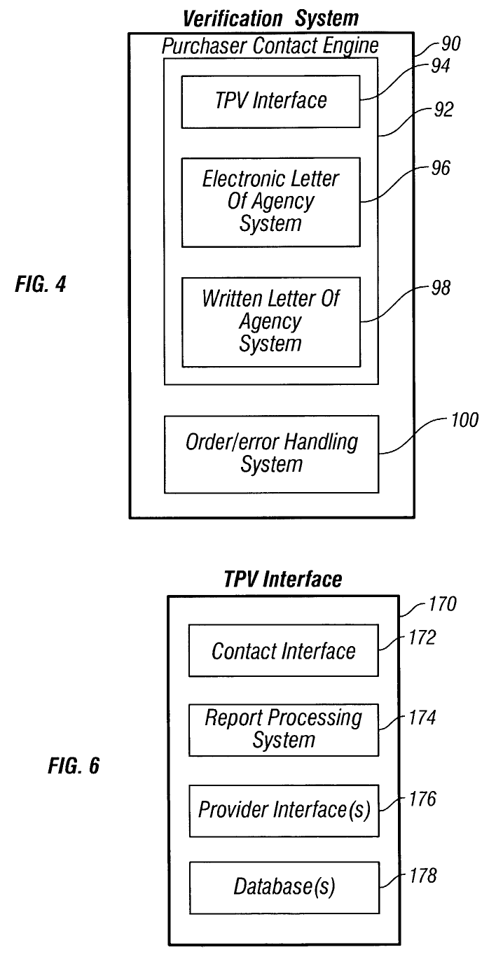

FIG. 4 is an exemplary embodiment of a verification system as seen in FIG. 3. The verification system 90 may have a purchaser contact engine 92 and order error handling system 100. The verification system 90 may function to verify the identity of the purchaser or obtain an electronic signature, among others, to conform with requirements for implementing a change in service.

The purchaser contact engine 92 may function to use the selected verification or authorization method to contact the potential customer. These methods may include a TPV interface 94, an ELOA system 96, and a WLOA system 98. Further, these systems 94, 96, and 98 may be selectively used in accordance with the specification of the potential customer, the service provider, or laws and regulations, among others. For example, some states require TPV while others permit an ELOA process. Further, some service providers may prefer one form of ELOA over another. In another example, the consumer may desire contact through ELOA instead of TPV or vice-a-versa.

The TPV interface may take various forms. These forms may include a website and/or transfer of data through an interconnected network, among others. For example, the potential customer or purchaser may indicate through a website form a desired time and date for a TPV phone call. The system may schedule the call in accordance with the limitations of the TPV system. For example, a TPV system may make calls shortly after transfer of the order information. In such a case, the TPV interface may await the time indicated by the consumer and transfer the data at or near that time. Alternately, the TPV interface may schedule the time with a TPV call center. However, various scheduling and interfacing methods may be envisaged.

The ELOA system 96, may take various forms. These forms may include an email system or website, among others. The ELOA system 96 may function to acquire an letter of agency or authorization with an electronic signature. The electronic signature may take the form of network data, electronic keys, encryption, and time or date stamp, among others. For example, the ELOA system 96 may email a document with an approved text provided by a service provider and/or in compliance with regional laws and regulations and instructions for completing the order process. Alternately, the ELOA may be a web page with the approved text and one or more buttons for accepting or rejecting the offer.

The WLOA system 98 may take various forms. These forms may include systems for creating letters, facsimiles, and other documents. Further the system may include printers and other devices for automating the preparation of WLOA. Like the ELAO system, the WLOA system may utilized text approved by the service providers and/or in compliance with regional laws and regulations.

The order/error handling system 100 may include means of organizing and reporting responses to ELOAs, TPVs, and WLOA. In addition, the system 100 may complete the processing of orders. For example, if a completed ELOA is returned, the system may process the order and submit it to the service provider.

The order/error handling system 100 may place orders using HTTP, FTP, facsimile, data files, and printed forms, among others. For example, the system 100 may use an HTTP POST method to submit data to a service provider order system. Alternately, the system 100 may compile a data file of orders and submit it through FTP. Further, the system may prepare a form for printing. However, various means may be envisaged.

The order/error handling system 100 may also process reports from the TPV system to determine status of orders in conjunction with the TPV interface 92. In the case of missed calls, the system 100 may reschedule calls or notify an attendant. The system 100 may also process ELOAs in conjunction with the ELOA system 96. Further, the system 100 may work with the WLOA system 98 to process WLOA replies. Further, the system 100 may work in conjunction with the provider report verification system and its associated error handling methods.

However, various embodiments of a verification system may be envisaged. These elements may or may not be included and may be together, separate, or in various combinations.

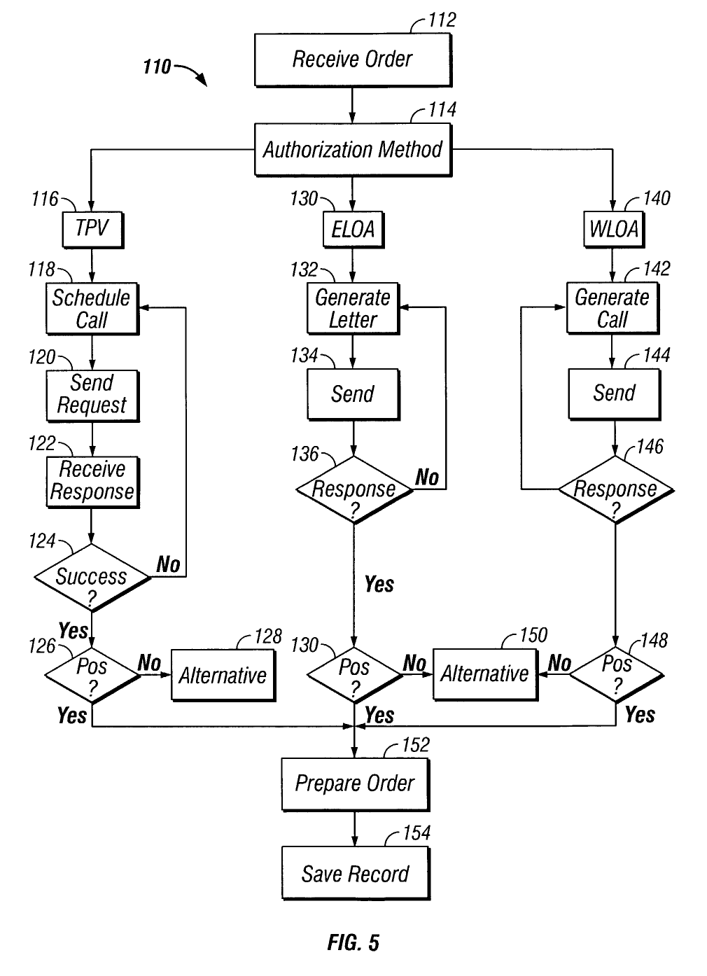

FIG. 5 is an exemplary method for use by the verification system. In the method 110, the order system receives an order as seen in a block 112. This order may have an associated method of verification or authorization. The method of verification or authorization may be selected as a result of laws and regulations, service provider preference, or purchaser preference, among others. For example the authorization and verification methods may include TPV 116, ELOA 130, and WLOA 140, among others.

If TPV 116 is selected, the verification system may schedule a call as seen in a block 118. This may involve sending a request to the TPV system through an interconnected network or other means as seen in a block 120.

The verification may receive a report from the TPV system with status and or verification data as seen in a block 122. This report may be processed to determine the verification status. For example the purchaser may not have answered the phone, or may have enter information incorrectly, requested cancellation, or authorized the transaction, among others. If contact with the purchaser was unsuccessful or an error occurred, the system may reschedule another TPV as seen in a block 124. If contact was successful, the system may determine whether the response was positive or negative as seen in a block 126. If the response was a cancellation, the system may seek to perform addition actions on the order as seen in a block 128. These actions may include discarding the order, re-verification, or checking the order data, among others. However, if the response is positive the order may be prepared as seen in a block 152.

If the selected method of verification or authorization is ELOA 130, the system may generate the text of the letter as seen in a block 132. This text may include instruction, legal statements, and text preferred by individual service providers. The text may be sent to the purchaser as an email or on a web page as seen in a block 134. The purchaser may then respond to the email or press a button on the web page.

If a response is not received, another letter may be generated as seen in a block 136. This process may be repeated for a set number of attempts. If a response is received, the system may determine whether the response was positive or negative/flawed as seen in a block 138. If the response was negative or flawed, the ELOA may be resent, discarded, or checked for errors, among others as seen in a block 150. These alternatives may be performed for example, by placing various ELOA responses in folders, directories, or queues, among others, for processing or observation by an attendant. However, if the response is correct and positive, the order may be prepared as seen in the block 152.

Similarly, a WLOA 140 may be prepared, sent, resent, or tested. If no response is received or the response is erred, the WLOA may be resent checked or discarded. However, if the response is positive, the order may be processed as seen in the block 152.

In conjunction with the order preparation, the ELOA, TPV record, or WLOA may or may not be saved in a service provider accessible system as seen in a block 154. For example, the ELOA may be saved for access by the service provider in the event that the order is disputed. Similarly, data useful for contacting the third-party verifier and retrieving confirmation data may or may not be stored and accessible.

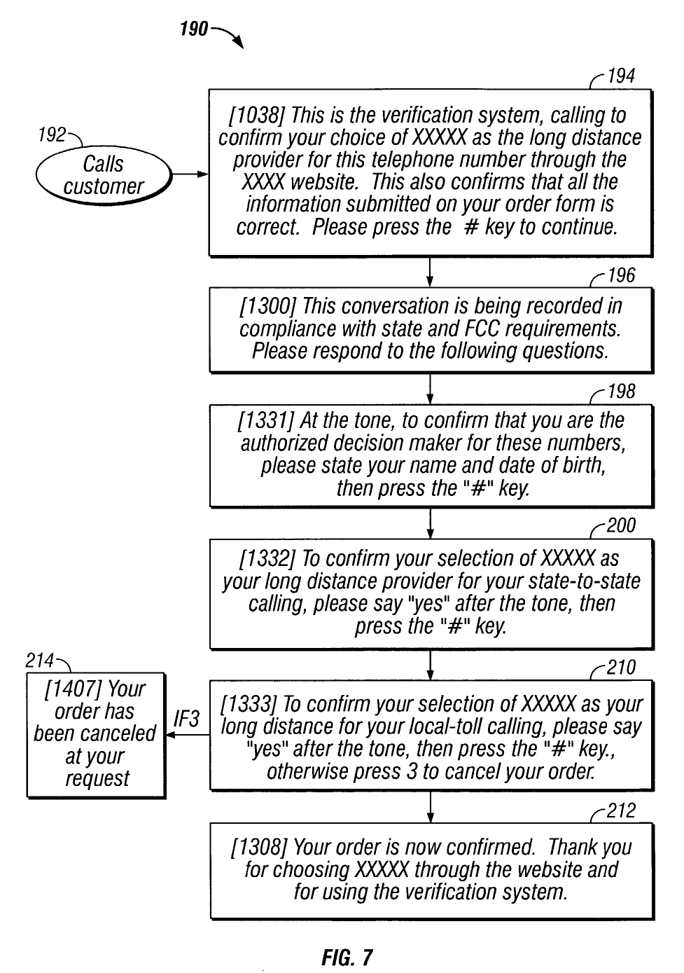

FIG. 6 depicts an exemplary embodiment of a TPV interface as seen in FIG. 4. The TPV interface 170 may include a contact interface 172, a report parsing system 174, a provider interface 176 and a database 178. The TPV interface may interact with the third-party verifier to acquire verification for an order.

The contact interface 172 may be an interface between the third-party verifier and order system. The contact interface 172 may schedule verifications and receive verification data. For example, the contact interface 172 may take the form of an email interface for sending and receiving emails containing data. Alternately, the interface 172 may be a web interface, FTP interface or other network interface. However, the interface 172 may take various forms.

The report processing system 174 may process reports from the third-party verifier to determine success of contacting and status of the order. The report processing system 174 may also determine which orders are associated with the data in the report and update the status of the order. Further, the report processing system 174 may instigate a change order processing or queuing. As a result, the report processing system 174 may update databases 178, among others. However, the report processing may also be performed manually.

The system 170 may also provide access to providers for retrieving data. The provider interface 176 may permit the service providers to access the system 170 and retrieve data useful in locating verification records at the third-party verifier. However, the provider interface 176 may exist as part of the order system and/or verification system.

The databases 178 may take various forms. These databases 178 may or may not also exist as part of the order system and/or verification system.

Each of these elements may or may not be included and may be together, separate, or in various combinations. Further, each of these elements may interface with other elements of the TPV interface 170, verification system or order system.

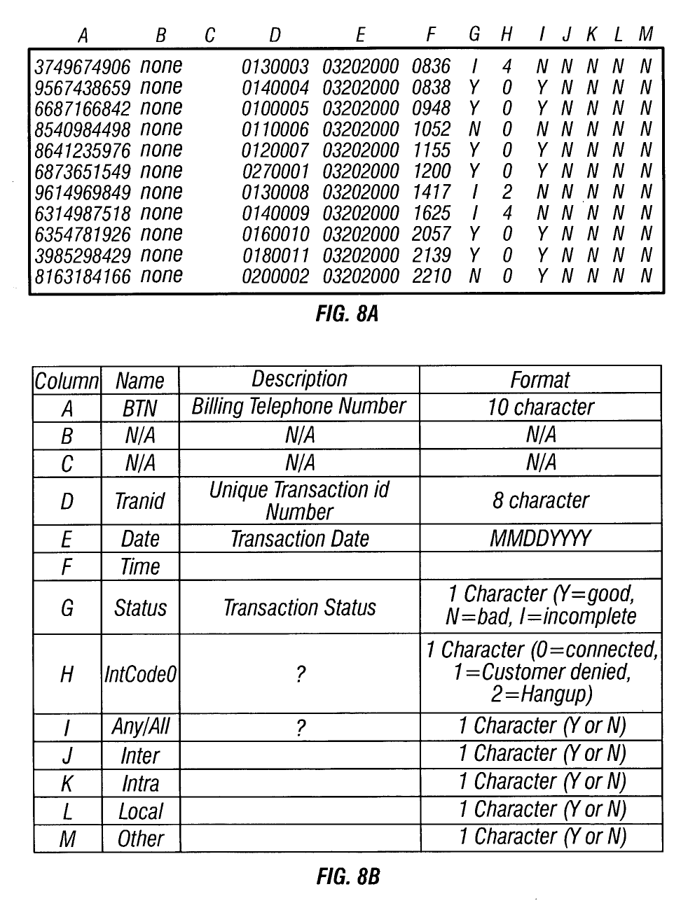

In one exemplary embodiment, the TPV interface 170 may contact the third-party verifier through email, FTP, or HTTP to schedule a call. The third-party verifier may then use a script such as the one seen in FIG. 7. The third-party verifier may call a customer as seen in a block 192. The potential customer may then be request to submit information and confirm or deny a desire to complete the order. The script may be customized for the agency service, service provider, or regional laws and regulations. Further various service providers may have separate scripts. The script may or may not be specified in during the scheduling of the TPV.

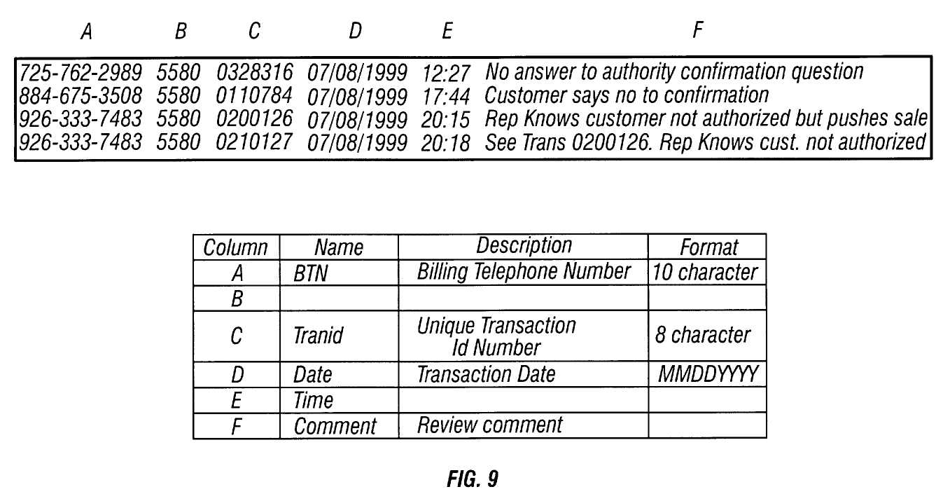

The third-party verifier periodically sends a report to the agency service. This report may be posted, sent via FTP or HTTP, or emailed, among others. FIGS. 8A and 8B are an exemplary embodiment of a callback report. In this exemplary embodiment, the callback report includes a customer identification such as a telephone number. The report may also include other data associated with the script or the result of the call such as, but not limited to, date, time, status, acceptance, responses, and locations, among others. A report processing system may process this data and associate it with the appropriate orders. Then submit the orders for further processing or submission to the service provider.

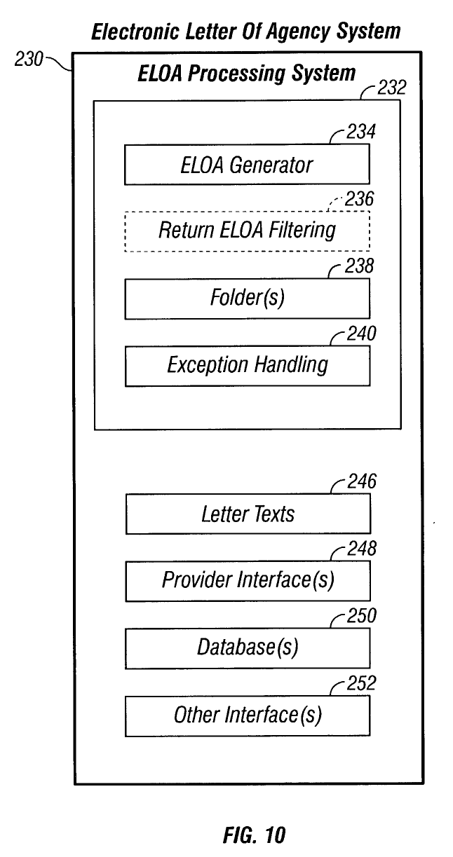

FIG. 9 shows another exemplary embodiment of a TPV report. In this case, the report may be from a call center where calls are processed by personnel. This report may also be processed automatically through language construction or manually. In the case of manual processing, the system may associate the comment section with an order and request an attendant to interpret the comment. In this manner, the processing of TPV reports may be, at least to some extent automated, reducing costs and time.

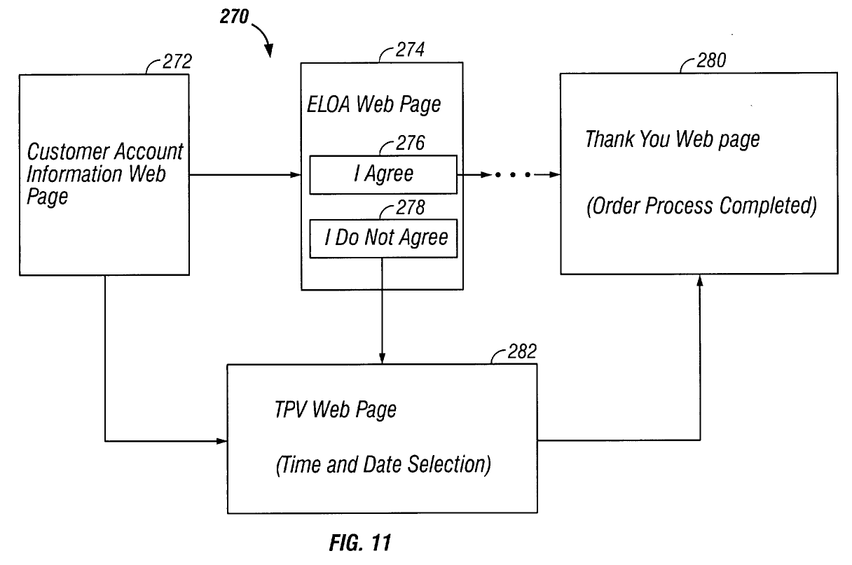

Turning to FIG. 10, the ELOA system 230 may have an ELOA processing system 232, letter texts 246, provider interfaces 248, databases 250, and other interfaces 252. The ELOA system 230 may function to prepare and process ELOAs and ELOA responses. However, these elements may or may not be included and may be together, separate or in various combinations.

The ELOA processing system 232 may function to generate, send, and process ELOAs. The ELOA processing system 232 may have an ELOA generator 234, a Filter 236, processing folders, directories, or queues 238, and exception handling rules and programming 240. For example, the ELOA processing system 232 may take the form of an email engine or a website form and scripts, among others.

The ELOA generator 234 may compile the ELOA using letter texts 246 and data about the customer, service provider, laws and regulations, and agency service, among others. The generator 234 may compile the text and create, for example, an email with the ELOA and response instructions or a web page with a form or response controls such as buttons. The email or web page may then be sent or presented to the potential customer. The customer may then respond.

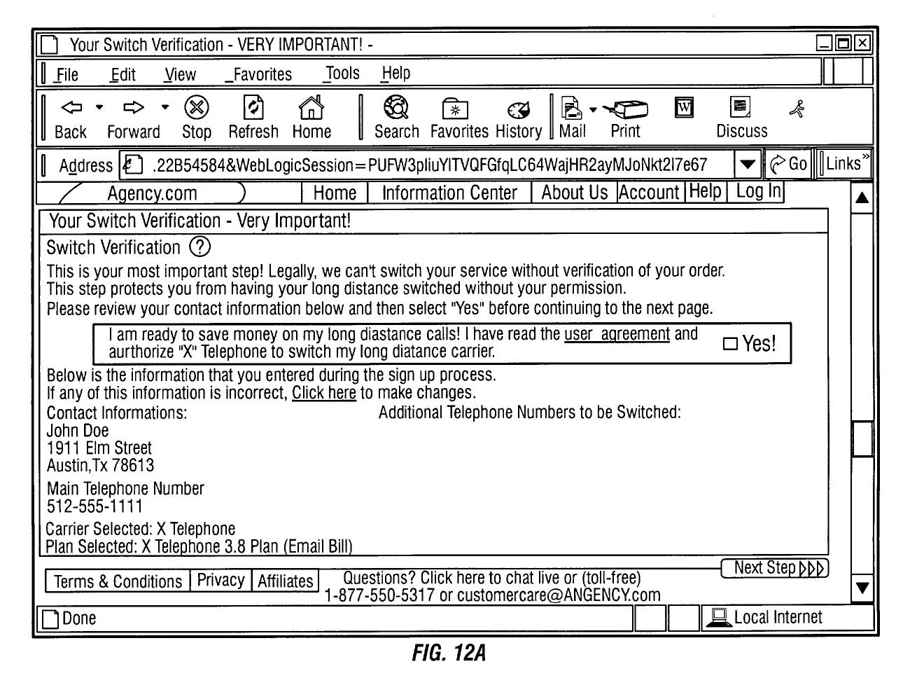

For example, FIG. 11 shows an ELOA process and one potential interaction between elements of the order system or verification system. The potential customer may provide account information as seen in a block 272. The potential customer may then select or be directed to one of several verification methods. In this example, the customer may be directed to an ELOA web page or alternately a TPV scheduling page. However, the verification method may be determined by regional regulations, provider preference, and agency service preference, among others.

As seen in a block 274, the customer may select an agree button 276 or a do not agree button 278. Depending on their selection, the potential customer may be directed to a “thank you” page or the TPV scheduling page as seen in blocks 280 and 282 respectively. Alternately, the do not agree button 278 may not be included.

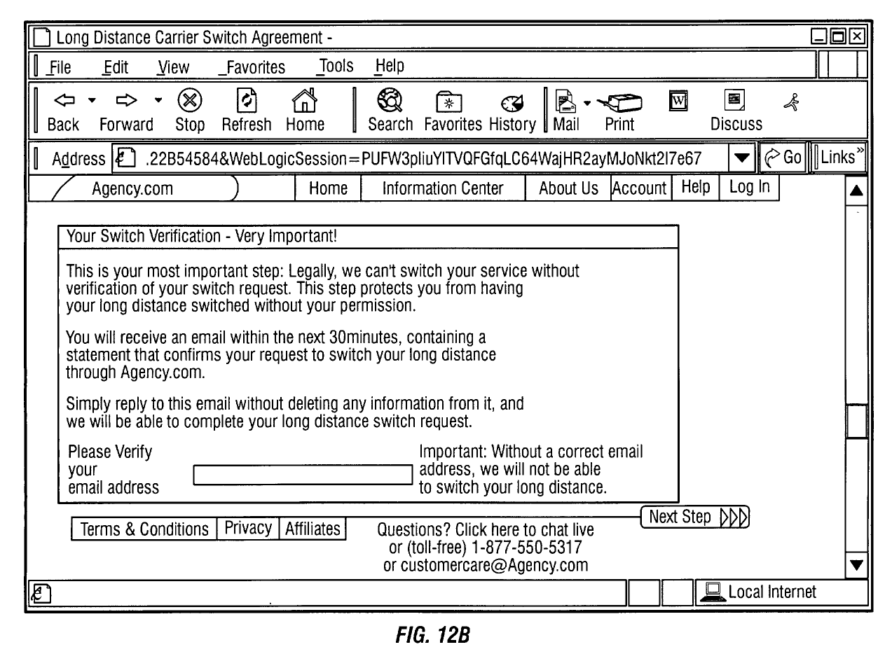

FIG. 12A depicts an exemplary embodiment of an ELOA web page. The ELOA web page may have the generated ELOA text and response buttons. Alternately, FIG. 12B depicts an exemplary embodiment in which the customer enters an email address to which an ELOA may be sent.

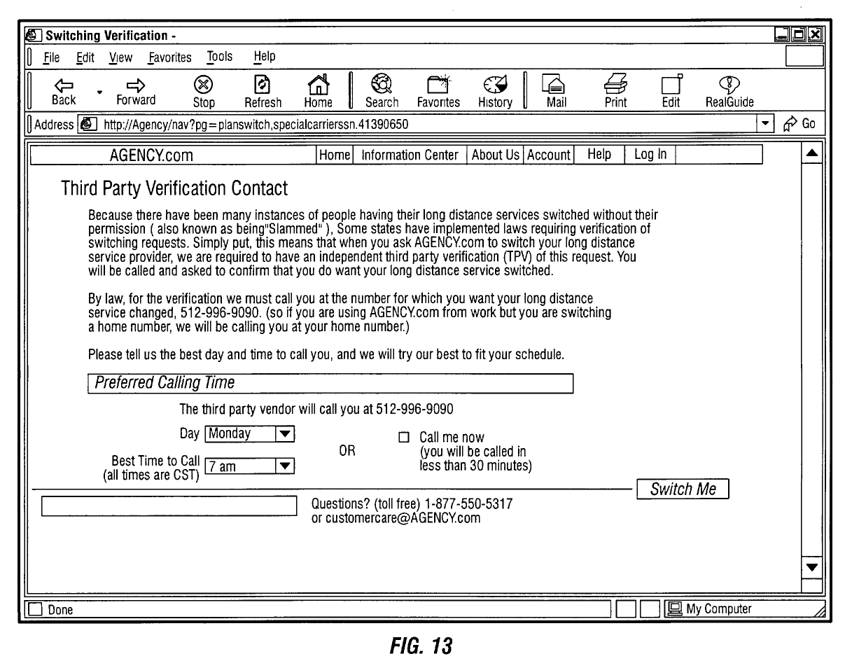

FIG. 13 depicts the TPV scheduling page with a form for selecting a callback time. In this manner, the customer may be directed to alternatives if they do not accept the ELOA web page method or regional regulations, provider preferences, and/or agency service preferences lead to the TPV callback method.

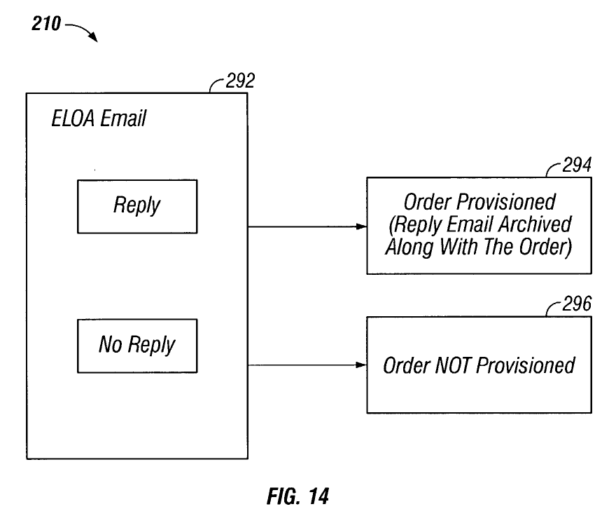

In another example, FIG. 14 depicts an ELOA email method. In a block 292, an ELOA email is sent. The potential customer has the option to reply or not. If the customer replies the email ELOA is further processed as seen in a block 294. Alternately, the order may be rejected as seen in a block 296 or the ELOA sent again. In one exemplary embodiment, if no response is received, a customer notification engine may send the ELOA again.

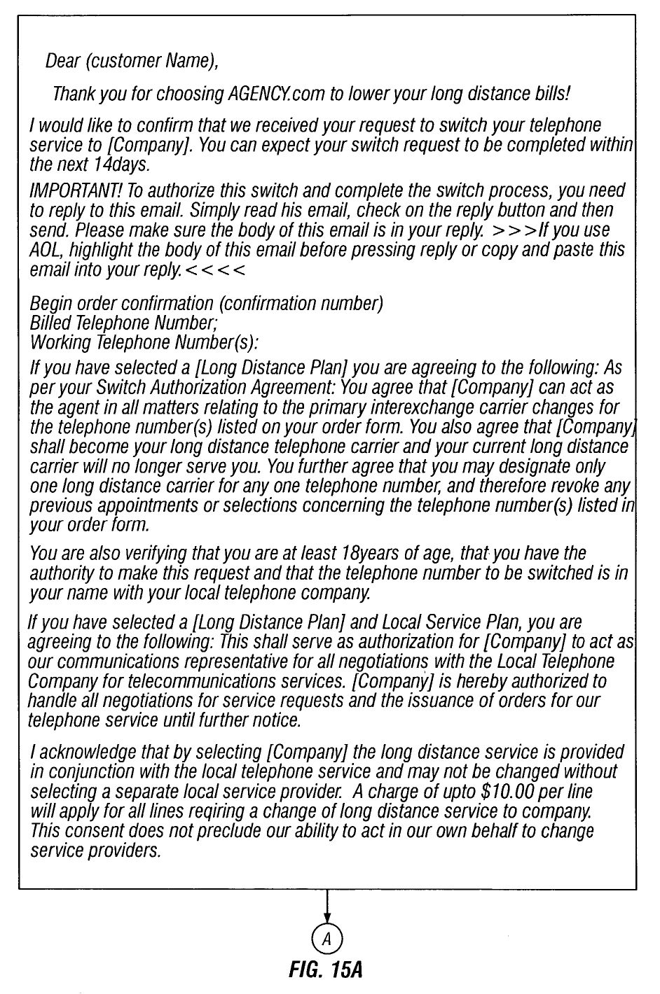

FIGS. 15A and 15B are an exemplary embodiment of an ELOA email message. Similar to the ELOA web page, text is included that was generated for the specific service provider, regional laws and regulations, and agency service.

Returning to FIG. 10, the filters 236 may take the form of scripts, programs or rules for filtering and sorting the returned ELOAs and/or associating the returned ELOAs with orders. For example, these scripts may take the form of Active X scripts or programs, VB scripts, compiled programs, and Java programs, among others. These scripts may be incorporated for example, into an email system. Alternately, these scripts may be CGI scripts and programs using similar languages and formats.

In one exemplary embodiment, the scripts may be Java scripts with Java Mail API interfacing with an Exchange email system. The scripts may read the returned ELOAs to determine if the returned ELOAs have enough text between keywords. Also, the filters 236 may read the text for key phrases and observe size.

The filters 236 may function to place the ELOAs and/or orders in folders, in directories, or on queues that may then be processed. For example, an accepted ELOA may be placed in a queue for processing the order. This processing may include a review by an attendant and automated order processing. However, various processes may be envisaged. Further, an cancelled order may or may not be discarded or checked for errors. Alternately, an erred ELOA or one for which an exception exists may be placed in folders for further processing.

In the event of an exception, scripts and rules may be used to determine subsequent action. The exception handling system 240 may further sort ELOAs or orders. For example, if an ELOA is not returned, the exception handling system 240 may initiate a subsequent sending of the ELOA. Similarly if an erred ELOA is returned a subsequent ELOA may be initiated.

Further, the ELOA processing system 232 may permit access by attendants to further process orders and check ELOAs. For example, the system 232 may include an email like interface for ELOA processing by attendants. Alternately, the system 232 may include a file system or web-based browser system for processing orders and ELOAs.

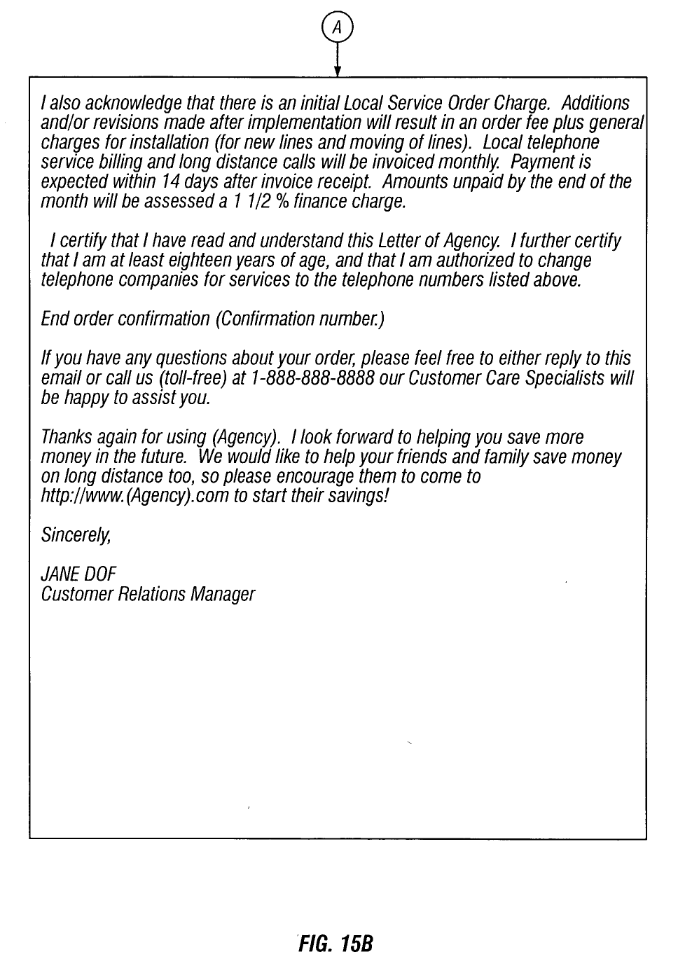

FIG. 16 depicts an exemplary method of a processing of an ELOA email. In the method 310, ELOAs may be returned to an ELOA inbox 312. Filters may move the ELOAs from the inbox in accordance with scripts, business rules, and other filters. For example, the first step may be to determine if the email is a returned ELOA. The ELOA may then be moved to a returned ELOA folder 314. The ELOA may be further filtered into sub-folders. For example, if the ELOA is acceptable it may be moved to an accepted folder 316. From there it may be further processed either manually or through the application of further filters to accepted/processed folders associated with specific service providers, 318 and 319. Alternately, if the ELOA is one returned because of an incorrect address it may be placed in a folder 320. Additional filters and business rules may be applied to further process the order into a bad address processed folder 321. Similarly, the ELOA may be placed in a cancelled folder 322, problem folder 326, rejected folder 328, and review folder 332 in accordance with various rules and requirements. Additional rules and filters may be applied to each of these folders, directories, or queues and the ELOAs directed to sub folders 324, 327, and 330. The application of rules may be performed manually. In some cases, review of an ELOA with exceptions or to which other rules do not apply may be performed by a person. This review may also relate to ELOAs for which specific rule violations occur. For example, a folder for review of bad addresses may be implemented as seen in a block 334.

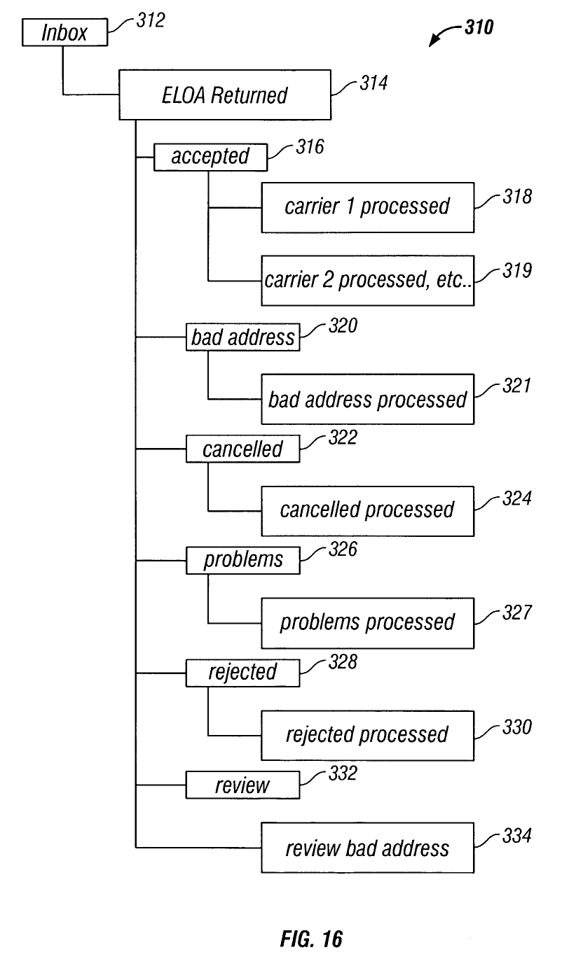

In a further exemplary method seen in FIG. 17, the ELOA processing system may receive a response as seen in a block 352. The filters may determine whether enough text exists between key phrases as seen in a block 354. If it does, the email may be forwarded to a representative for review as seen in a block 360. If the ELOA contains the proper legal text as seen in a block 362, the representative may move the ELOA to the accepted folder for processing as seen in a block 366. The system may then submit the order as seen in a block 368. If the ELOA does not have enough text or does not have the appropriate legal text, the ELOA may be moved to another folder, discarded, or sent again as seen in a block 358.

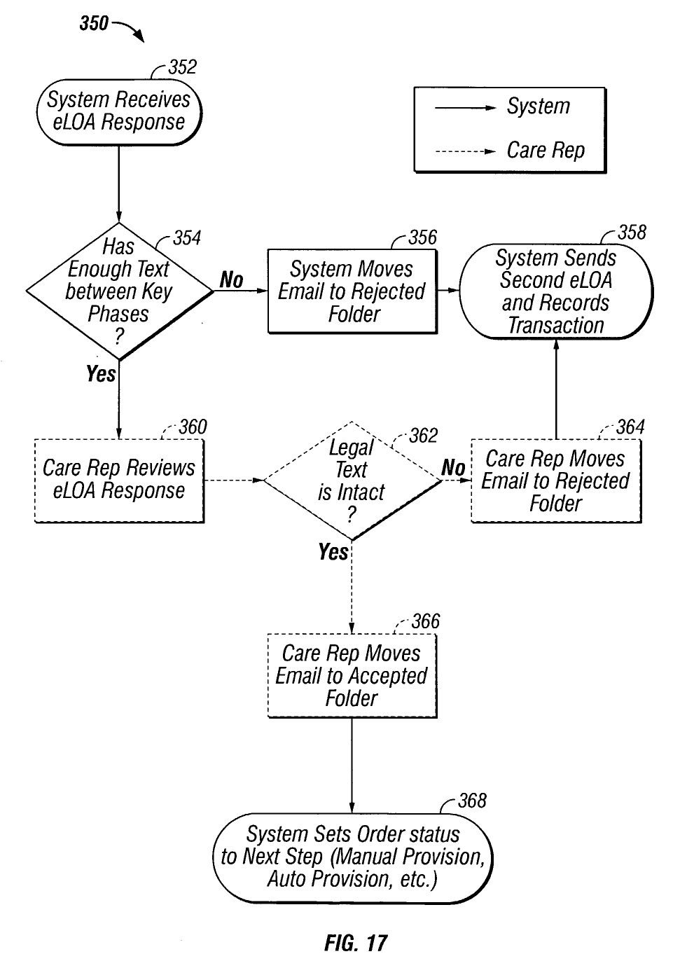

Another exemplary method is seen in FIGS. 18A and 18B. In this exemplary method, the ELOA email may be checked for a proper email subject line or other indicator as seen in a block 374. If the email has the proper subject line, the email ELOA may be moved to the Returned Folder as seen in a block 376. ELOA may then be checked for a valid email address as seen in a block 378. If the email address is invalid, the email may be moved to a bad email address process as seen in a block 380.

If the email address is valid, the email may be check for key phrases, order parameters and enough text as seen in blocks 382, 384, and 388, respectively. If it fails one of these tests, the ELOA may be rejected as seen in a block 384 and 386. If rejected, another ELOA may be sent or the order cancelled. However, if it passes, the ELOA may be associated with an order as seen in a block 390. If no order exists, the ELOA may be moved to problem folder as seen in a block 392.

However, if an order is associated with the ELOA, the ELOA may be moved to the review folder as seen in a block 394. The ELOA may be reviewed to determine if it is a cancellation. If it is the order may be cancelled. However, if the ELOA is not a cancellation, it may be checked for intact legal text as seen in a block 398. If the legal text is not intact, the ELOA may be rejected as seen in a block 400. However, if the legal text is intact, the ELOA may be accepted as seen in a block 402. The order may then be processed as seen in a block 404.

Returning to FIG. 10, the ELOA system 230 may also have letter texts 246. These texts may include texts specific to regional laws and regulations, service providers, and marketing campaigns, among others. With these letter texts 246, the ELOAs may be customized.

The ELOA system 230 may have provider interfaces 248. With these interfaces, the service providers may access a database of ELOAs to verify proper order processing and resolve disputes with customers.

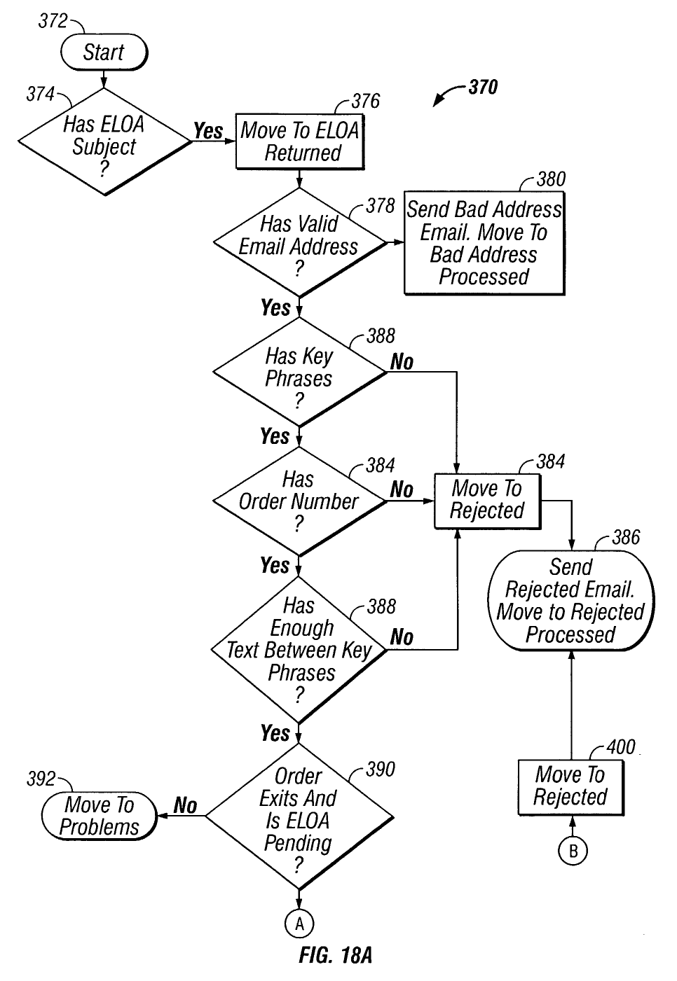

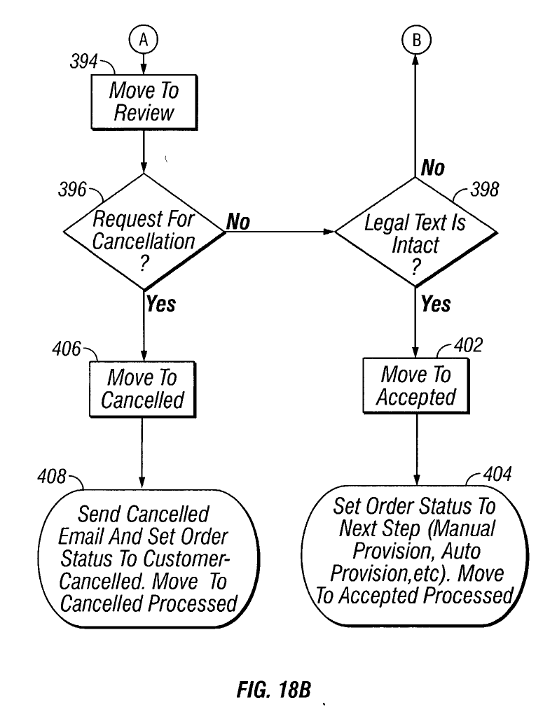

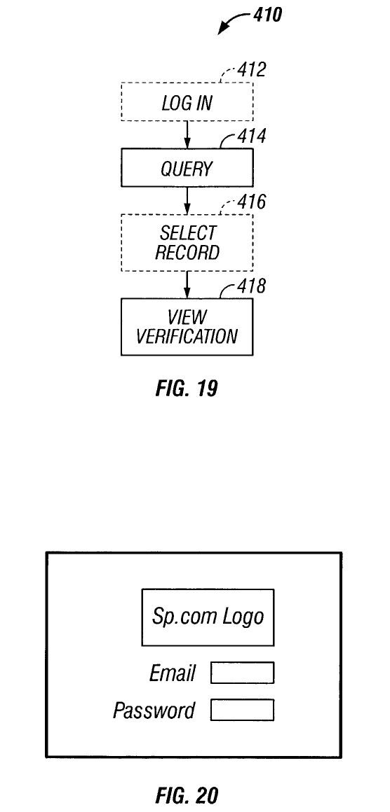

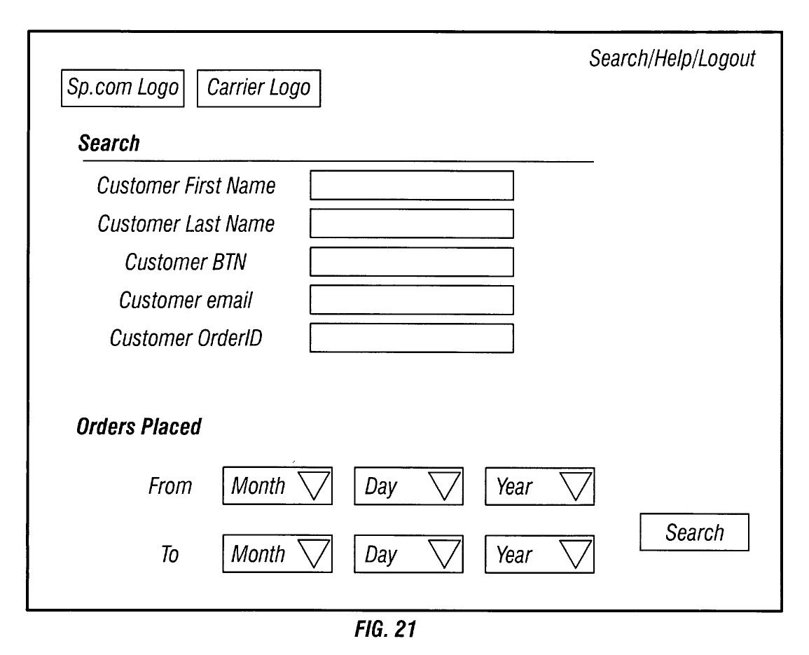

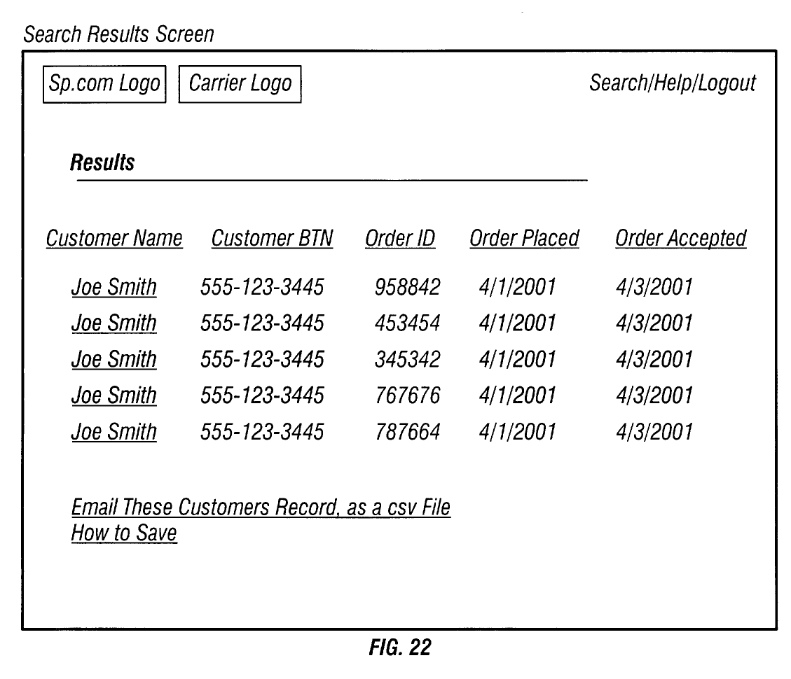

For example, the provider interface 248 may be a website. As seen in FIG. 19, the provider may login to the website, query the databases, select the desired record and view the ELOA or verification information. FIG. 20 is an exemplary embodiment of a login web page for a provider. The provider may enter a provider ID and password. The provider may then be provided with a query page, for example, FIG. 21. The query page may have a form and several fields for entering query data. The query may result in the location of various records. For example, if a phone number were entered, the name of past owners or co-owners may appear as seen in FIG. 22. The service provider may then select the appropriate order or ELOA record and view the ELOA. For example, the service provider may select the most recent order or the order based on name, among others. FIG. 23 is an exemplary embodiment of an ELOA presented to the service provider. The ELOA may be presented with the electronic signature data.

Returning to FIG. 10, the ELOA system 230 may have databases and other interfaces. These databases may or may not be the same as those of the order system or verification system or may interface with other systems. Further, various interfaces may be provided for access between elements of the order system, verification system, ELOA system, TPV system, service provider systems, potential customers, attendants, and representatives, among others.

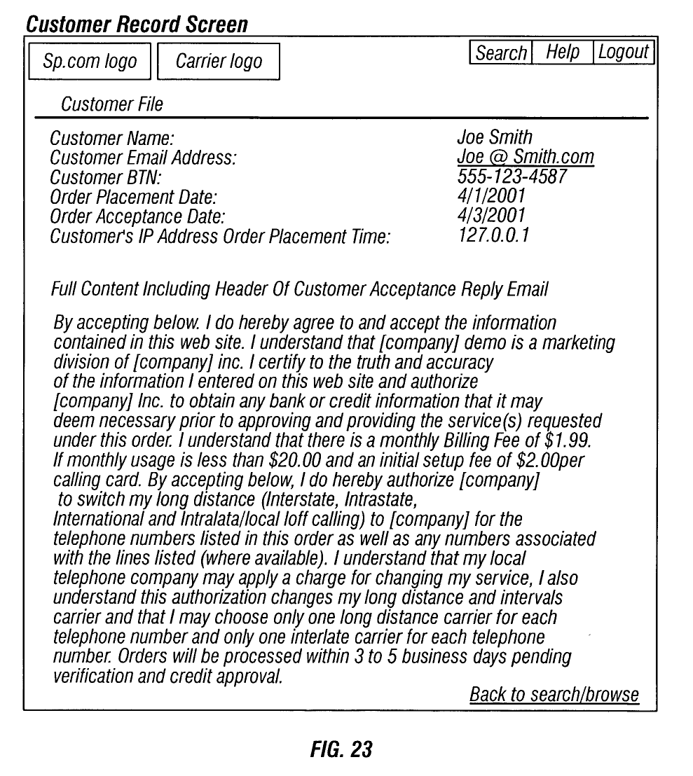

FIG. 24 shows a provider report reconciliation system 430. The provider report reconciliation system 430 may function to process reports with customer status and/or billing information received from service providers. The system 430 may have a provider report processing system 432, an order pairing system 434, a set of business logic rules 436, an exception handling system 438, an order error handling system 440, databases 442, and interfaces 444. However, these elements may or may not be included in the system 430 and may be together, separate, or in various combinations.

The provider report processing system 432 may process the report provided by the service providers. Each report may take a differing format. Therefore, the provider report processing system 432 may function to recognize the report format and/or apply differing processing procedures to differing report formats. In one embodiment, the provider report processing system 432 converts reports from varying service providers to a universal report format. However, various approaches are envisaged.

The reports may have a customer identification number and an order status. Further, the reports may or may not contain customer usage data. In one exemplary embodiment the report may list phone numbers and TCSI codes.

The order status and/or usage data may be paired with an order or customer record. For example, the order pairing system 434 may pair a customer or order with the status and/or usage data from the report. However, the order pairing system 434 may be combined with the provider report processing system 432. In the event that an order can not be associated with part of the data or more than one order is associated with the data, the data may be sent to the exception handling system 438. For example, the report may have an incorrect phone number or the phone number in the report may match several past and present customers.

However, if an order is associated with the data, business logic rules may be applied to determine what actions if any to take in regards to the order. For example, the TCSI code may indicate that an order or customer is continuing service. In this case, the system may do nothing or send a thank you email to the customer. On the other hand, a TCSI code may indicate a successful switching of the customer, a failed switching, a cancellation, a discontinuation, a failure to pay, or a dispute, among others. In these cases, the business logic rules 436 may be employed to determine to which queue or process to direct the order or customer record. The queue or process may take the form of a directory, folder, status field change in the record, or listing in a database table, among others. For example, the queue may be a date-ordered listing in a database table or query result to which processing is applied in an ordered manner.

In one exemplary case, if a switch failed or the order is in dispute, the order or customer record may be directed to an order error handling 440. In this manner the processing of orders and maintenance of customer data may be automated.

The exception handling system 438 may function to pair orders with the appropriate data. For example, the exception handling system 438 may interface with an attendant to determine to which order the data applies. Alternately, another set of business rules may be applied.

The order error handling system 440 may also function to interface with an attendant to determine what action to take with erred orders or disconnected customers. For example, a customer may have a lock associated with their line which prevents switching and requires the customer to contact the phone company. In this case, the system 440 may notify the customer of this problem or interface with another system such as a customer notification system to notify the customer of this problem. In another example, if the order is in dispute, the system 440 may send another ELOA or contact the customer or, again, interface with another system to send the ELOA or contact the customer. However, various actions may be envisaged in association with order errors.

Further, the system 440 may have various databases 442 and interfaces 444. These databases 442 may take various forms and may be the same or different from those of the ELOA system, order system, and verification system, among others. The interfaces 444 may include various software interfaces between elements, user interfaces, and interfaces with other systems, service providers, attendants, representatives and customers, among others.

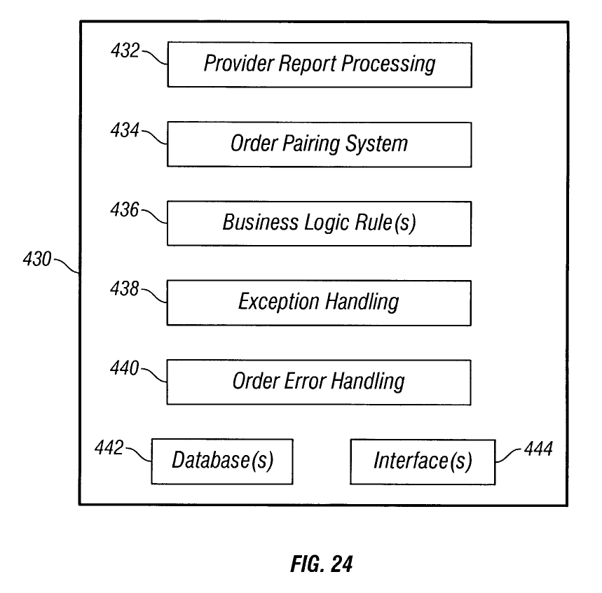

FIG. 25 is an exemplary method for use with the system of FIG. 24. In the method 450, the system may receive customer data from one or more service providers as seen in a block 452. The customer data or report may take various forms including those above. For example, the report may include an identification number, a status code, and or usage data. In one exemplary embodiment the report may include a phone number and a TCSI code.

The report may be parsed or processed as seen in a block 454. Further, the data may be associated with individual customer records or orders as seen in a block 456. The data and/or status codes may be interpreted and actions may be assigned in accordance with various business rules as seen in blocks 458 and 460. In addition, the method may include steps for handling exceptions and order errors.

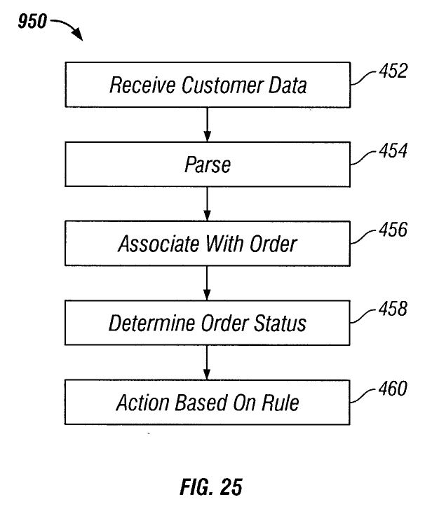

FIG. 26A depicts an exemplary embodiment of a report. The report may have a customer identification such as a phone number and an associated TCSI code. However, the report may have additional data. Using the customer identification, the system 430 may associate the TCSI code with an order record. FIG. 26B is an exemplary embodiment of a table of TCSI codes and their meaning. From the TCSI codes, the system 430 may apply business logic rules to determine an appropriate action. For example, FIG. 26C depicts a table of TCSI codes and actions associated with those rules.

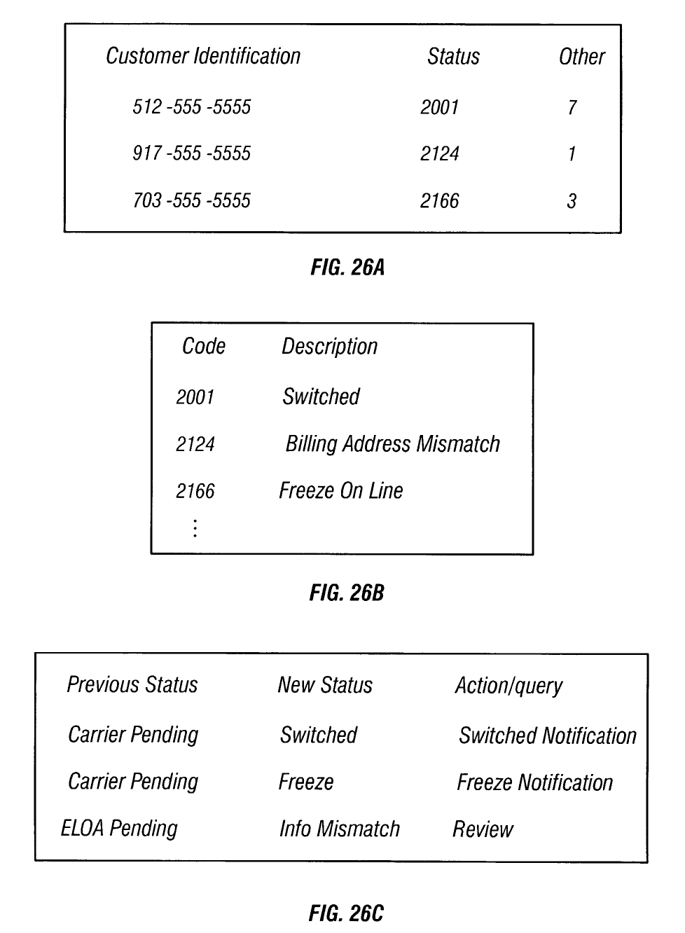

FIG. 27 is a schematic block diagram depicting an exemplary embodiment of a customer notification system. The customer notification system 470 may have an ELOA interface 472, an order interface 474, a profile interface 476, other interfaces 478, and databases 480. However, these elements may or may not be included and the elements may be together, separate or in various combinations.

The ELOA interface 472 may interact with an ELOA system to resend ELOAs in the event that no response is received within a given period of time. In addition, the ELOA interface 472 may interact with the ELOA system to send notifications to customers for which other exceptions relating to returned ELOAs exist. The system 470 may resend ELOAs a specified number of attempts and then change the status of an order.

The order interface 474 may interact with systems such as a provider report reconciliation system to notify customers of their status. For example, the system 470 may send a thank you note to a customer once the order status shows acceptance. In another example, the system 470 may send another ELOA in the event of an order error or notify the customer of a line lock. However, various notices and conditions leading to a notice may be envisioned.

The system 470 may have a profile interface 476. This interface 476 may interact with a profile engine or customer data to send notifications of service plans or options. For example, customer usage data may be used to determine a more optimal plan for the customer. The system 470 may be directed to send a notification to the customer.

The system 470 may have other interfaces 478. These interfaces may interact with attendants or other systems. The system 470 may also have access to databases 480. These databases may or may not be the same as those of order system, verification system, reconciliation system, commission verification system, and profile engine, among others.

In addition, the system 470 may have instructions for providing the functionality described above. These instructions may take the form of scripts and/or programs and may be written in various languages including Visual Basic, Java, Perl, Javascript, C, or C++, among others.

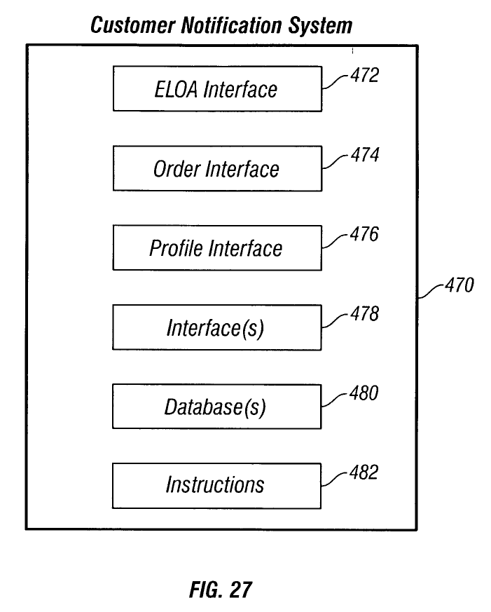

FIG. 28 depicts an exemplary embodiment of a commission verification system. Report data from the service providers may be used to determine commissions and compare the expected commissions with those provided by the service providers. The commission verification system 510 may have a set of commission rules 512, databases 514, and a process engine 516. However, the system 510 may or may not have each of these elements and these elements may be together, separate, or in various combinations.

The commission rules 512 may be extracted from commission schedules and contracts between the service provider and the agency service. These commissions may be based on usage, length of customer contract, number of customers, and/or other factors.

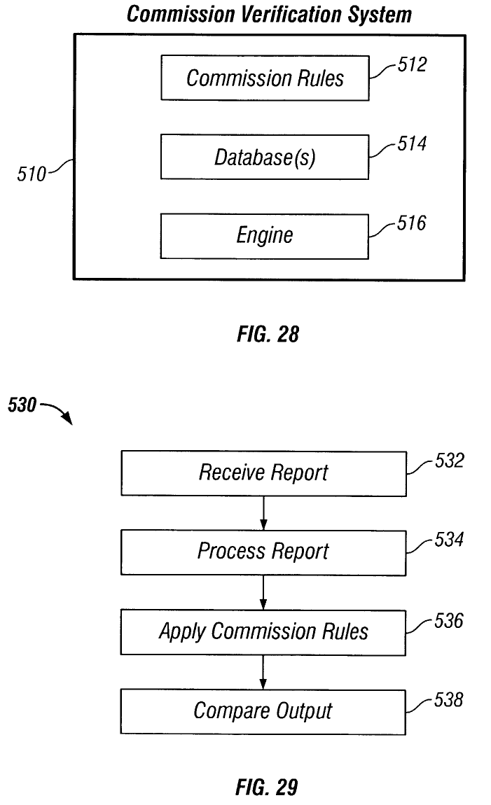

The processing engine 516 may use the commission rules 512 in conjunction with data from the databases 514 and usage reports provided by the service providers to determine an expected commission or compare commissions with usage data. In this manner, the verification of commissions may be automated. The databases 514 may be the same or different from those of the order system, verification system, ELOA system, and provider report processing system, among others. FIG. 29 depicts a block flow diagram of an exemplary method for use by the commission verification system. In the method 530, the system may receive a report from a service provider as seen in a block 530. This report may include a customer identification number and usage data, among other information. The format of the report may vary between service providers.

The report may then be processed as seen in a block 534. This processing may or may not place the report in a common format. In one embodiment, the processing may associate the usage data with an order or customer. The usage data may be associated with a commission schedule or contract rules.

These rules may be applied to determine the expected commission as seen in a block 536. These rules may take the form of various logic rules associated with contracts, commission schedules, among others. The resulting output may then be compared to or verified with payment received from the service provider as seen in a block 538.

Furthermore, the usage data or the report in the common format may be provided to other systems for determining more optimal service plans, adapting profile parameters, and evaluating marketing strategies.

As such, a system and method for automating authorization processes is described. In view of the above detailed description of the present invention and associated drawings, other modifications and variations will now become apparent to those skilled in the art. It should also be apparent that such other modifications and variations may be effected without departing from the spirit and scope of the present invention as set forth in the claims which follow.

We claim:

1. A method for automated processing of an electronic letter of agency, the electronic letter of agency being associated with an order, the method comprising:
sending the electronic letter of agency to a purchaser, the electronic letter of agency comprising a legal text;
receiving a returned electronic letter of agency from the purchaser, the returned electronic letter of agency comprising the legal text and an electronic signature;
sorting the returned electronic letter of agency into a processing queue in accordance with at least one business logic rule, and
associating the returned electronic letter of agency with the order.

2. The method of claim 1, the method further comprising:
generating the electronic letter of agency with text specific to a service provider associated with the order.

3. The method of claim 1, wherein the legal text is associated with laws and regulations of a region associated with the order.

4. The method of claim 1, wherein the electronic letter of agency is incorporated into an e-mail message.

5. The method of claim 1, wherein the electronic letter of agency is incorporated into a web page.

6. The method of claim 1, the method further comprising:
submitting the order to a service provider in accordance with the at least one business logic rule.

7. The method of claim 1, the method further comprising:
storing the returned electronic letter of agency in a system accessible by a service provider associated with the order.

8. The method of claim 1, the method further comprising:
sending a subsequent electronic letter of agency to the purchaser.

9. The method of claim 1, wherein the order is associated with a telecommunication service.

10. A method for automated status switching of customer records, the method comprising:
receiving a service provider report, the service provider report comprising at least one customer identification number associated with at least one status code,
associating the at least one status code with a customer record, the customer record being associated with the customer identification number; and
selectively switching the status of the customer record in accordance with at least one business logic rule associated with the at least one status code.

11. The method of claim 10, wherein the service provide report is associated with a telecommunications service.

12. The method of claim 10, the method further comprising:
contacting a customer associated with the customer record to provide information associated with the status code.

13. The method of claim 10, the method further comprising:
sending an electronic letter of agency to a customer associated with the customer record and in accordance with the at least one business logic rule.

14. A system for automated processing of an electronic letter of agency, the electronic letter of agency being associated with an order, the system comprising:
software instructions for sending the electronic letter of agency to a purchaser, the electronic letter of agency comprising a legal text;
software instructions for receiving a returned electronic letter of agency from the purchaser, the returned electronic letter of agency comprising the legal text and an electronic signature;
software instructions for sorting the returned electronic letter of agency into a processing queue in accordance with at least one business logic rule, and
software instructions for associating the returned electronic letter of agency with the order.

15. The system of claim 14, the system further comprising:
software instructions for generating the electronic letter of agency with text specific to a service provider associated with the order.

16. The system of claim 14 wherein the legal text is associated with laws and regulations of a region associated with the order.

17. The system of claim 14 wherein the electronic letter of agency is incorporated into an e-mail message.

18. The system of claim 14 wherein the electronic letter of agency is incorporated into a web page.

19. The system of claim 14, the system further comprising:
software instructions for submitting the order to a service provider in accordance with the at least one business logic rule.

20. The system of claim 14, the system further comprising:
software instructions for storing the returned electronic letter of agency in a system accessible by a service provider associated with the order.

21. The system of claim 14, the system further comprising:
software instructions for sending a subsequent electronic letter of agency to the purchaser.

22. The system of claim 14 wherein the order is associated with a telecommunication service.

23. A system for automated status switching of customer records, the system comprising:
software instructions for receiving a service provider report, the service provider report comprising at least one customer identification number associated with at least one status code,
software instructions for associating the at least one status code with a customer record, the customer record being associated with the customer identification number; and
software instructions for selectively switching the status of the customer record in accordance with at least one business logic rule associated with the at least one status code.

24. The system of claim 23, wherein the service provide report is associated with a telecommunications service.

25. The system of claim 23, the system further comprising:
software instructions for contacting a customer associated with the customer record to provide information associated with the status code.

26. The system of claim 23, the system further comprising:
software instructions for sending an electronic letter of agency to a customer associated with the customer record and in accordance with the at least one business logic rule.

27. A method for automated commission verification, the method comprising:
receiving a service provider report from a service provider;
processing the service provider report to produce a processed report;
applying commission rules to data associated with the processed report to produce an output; and
comparing the output to one or more payments received from the service provider.

28. The method of claim 27 wherein the service provider report comprises usage data associated with a customer identification number.

29. The method of claim 28, the method further comprising:
adjusting a customer profile based on the usage data, the customer profile associated with the customer identification number.

30. The method of claim 29, the method further comprising:
determining an optimal plan based on the customer profile; and
notifying a customer associated with the customer profile of the optimal plan.

31. A system for automated commission verification, the method comprising:
software instructions for receiving a service provider report from a service provider;
software instructions for processing the service provider report to produce a processed report;
software instructions for applying commission rules to data associated with the processed report to produce an output; and
software instructions for comparing the output to one or more payments received from the service provider.

32. The method of claim 31 wherein the service provider report comprises usage data associated with a customer identification number.

33. The method of claim 32, the method further comprising:
software instructions for adjusting a customer profile based on the usage data, the customer profile associated with the customer identification number.

34. The method of claim 33, the method further comprising:
software instructions for determining an optimal plan based on the customer profile; and
software instructions for notifying a customer associated with the customer profile of the optimal plan.

35. A system for notifying customers, the system comprising:
an interface to an email engine;
an interface to a business logic system, the business logic system altering parameters associated with a customer order; and
instructions for creating and sending an email to a customer associated with the customer order, the email comprising a message associated with the parameters associated with the customer order.

36. The system of claim 35 wherein the business logic system is an ELOA system.

37. The system of claim 35 wherein the business logic system is a provider report reconciliation system.

38. The system of claim 35 wherein the business logic system is a profile engine.
